(19) United States
(12) Patent Application Publication
(10) Pub. No.: US 2020/0046591 A1
(43) Pub. Date: Feb. 13, 2020

(54) Modular Therapeutic Vibration Rehabilitation System

(71) Applicant: WiSys Technology Foundation, Inc., Madison, WI (US)

(72) Inventor: Jeffrey M. Leismer, Sheboygan, WI (US)

(21) Appl. No.: 16/345,916

(22) PCT Filed: Oct. 30, 2017
(86) PCT No.: PCT/US2017/058967

§ 371 Date: Apr. 29, 2019

(51) Int. Cl. A61H 1/00; A61H 1/02

(52) U.S. Cl. CPC A61H 1/005; A61H 1/0237; A61H 2201/164; A61H 2201/5084; A61H 2203/0431; A61H 2203/0437; A61H 2201/1671

(57) ABSTRACT

An apparatus for musculoskeletal stimulation allows a restoring element communicating with the limb support to provide a restoring force to the limb support that is dependent on displacement of the limb support from a neutral positions. The restoring force may be applied by a weight or a spring.

### CROSS REFERENCE TO RELATED APPLICATION

This application claims the benefit of U.S. provisional application 62/414,387 filed Oct. 28, 2016 and hereby incorporated by reference.

### STATEMENT REGARDING FEDERALLY SPONSORED RESEARCH OR DEVELOPMENT

### Background of the Invention

The present invention provides a method and apparatus for applying a stimulating vibration to a person's arms or legs and in particular to a modular apparatus providing restoring force to the arms or legs of the person in response to displacement of an arm or leg plate to enhance transmission of vibration forces.

During periods of disuse (physical inactivity), the body “deconditions” at a rapid rate, a phenomenon known as disuse atrophy. In deconditioning, muscle fibers reduce in strength and size, muscles shorten and denervate, tendons and ligaments develop adhesions and permanently lose their flexibility resulting in loss of range of motion and bones may lose their strength. Such deconditioning can result in an increased fall injury risk and secondary complications such as obesity, cardiovascular disease, diabetes, and other life-threatening ailments can arise.

Weight-bearing physical activity is the best-known method for reducing or reversing disuse atrophy, but the underlying causes of disuse atrophy often limit one's ability to perform the necessary exercises.

Harness-based treadmills and aquatic therapy pools are capable of enabling persons with reduced mobility to perform physical activity under partial bodyweight loading. However, these modalities are costly to acquire, require significant space in a rehabilitation facility, are difficult to operate and may also be impractical for weakened individuals.

Electrical stimulation is an alternative means of inducing muscle activation in users who are unable to perform physical activity on their own. However, electrical muscle stimulation is site-specific, meaning it affects tissue(s) only in the vicinity of the electrode supplying electricity to the muscle, and it can cause discomfort and pain if used as a sole means to maintain muscle strength in the absence of physical activity.

An alternative to the above techniques is vibration therapy. Typical vibration therapy provides whole body vibration with the user standing on a vibrating platform. This also can be impractical for users with limited mobility. U.S. Pat. Nos. 7,662,115; 9,283,134; US patent publication 2012/0209156; and US patent publication 2014/0276273 to the present inventor, each of which are hereby incorporated by reference, describe vibration therapy systems that may be applied to user limbs, such as the legs, with a recumbent or supine individual.

### SUMMARY OF THE INVENTION

The present invention provides a restoring element imparting a restoring force on the arms, legs, or core of the user. The restoring force may be applied to a push plate when an initial opposite force is applied to the push plate causing displacement of the push plate. The initial opposite force may be generated by the weight of the push plate and its associated components, weight of the user's legs, user's applied force against the push plate, treatment administrator, trainer, or assistant's applied force against the push plate, or motorized joint support which drives the limb into the push plate. The restoring force may be generated by a weight, spring, or motorized actuator (for example, as provided by U.S. patent application Ser. No. 14/208,477, filed Mar. 13, 2014, and hereby incorporated by reference) communicating with the push plate.

The present invention also provides an improved system for applying vibration therapy to user limbs that provides modularity of components to increase functionality and flexibility of the system. The invention permits a variety of body positioning modular components; arm, leg, or core exercise modular components; and a variety of user interactions and programming components to be attached to the system in an interchangeable and replaceable manner.

In one embodiment, the invention provides an apparatus applying an axial vibratory force to a limb of a user of the apparatus, the limb having at least first and second segments each having axes and communicating by a joint. The apparatus may have a seat; a limb support separate from and positioned in front of the seat to receive the limb of a user when the user is in a position sitting in the seat; a vibration system communicating with the limb support to provide a vibration force to the limb within a first excursion range; a restoring element communicating with the limb support to provide a restoring force to the limb support over a second excursion range larger than the first excursion range wherein the restoring force is dependent on displacement of the limb support from a neutral position; and a user joint restraint constraining motion of the user's limb against force exerted on the user's limb by the vibration system and restoring force.

It is thus a feature of at least one embodiment of the invention to increase the loads on the extremities to assist with transmission of vibrations across the joints.

The restoring element may be a weight having a center of gravity and communicating with the limb support whereby the center of gravity is lifted along a vertical axis when the limb support is displaced. The weight may be provided by a rocker providing rocking movement to the limb support toward and away from the user whereby displacement of the limb support occurs when rocking away from the user and the restoring force is applied to the limb support when rocking toward the user. The rocker may be a modular unit interchangeable to change a radius of curvature of the rocker.

It is thus a feature of at least one embodiment of the invention to apply a load across a full range of motion to enable agonist and antagonist muscle groups to pass through their optimal length for force generation capacity.

The restoring element may be a spring communicating with the limb support to compress or extend the spring when the limb support is displaced. The spring may be a spring-loaded hinge whereby displacement of the limb support occurs when rotating the limb support away from the user and the restoring force is applied to the limb support when rotating the limb support toward the user.

It is thus a feature of at least one embodiment of the invention to stimulate muscles with therapeutic vibrations while muscles are at optimal length to induce more forceful muscle contractions.

The limb support may be two separately displaceable foot supports receiving each of the user's feet separately and the restoring force is generated by the displacement of the opposite foot support.

It is thus a feature of at least one embodiment of the invention to stimulate each limb separately at different vibration and loading forces and to utilize alternating forces to create restoring forces in the opposite limb.

A user interface may display a graphic display of a program providing a user assessment.

It is thus a feature of at least one embodiment of the invention to provide interactive programs for the user to assess their muscle strength and range of motion and provide customized reports for users.

Displacement of the limb support may be along at least two orthogonal directions.

It is thus a feature of at least one embodiment of the invention to encourage a wide range of motion of muscle contractions.

In one embodiment, the invention provides an apparatus applying an axial vibratory force to a limb of a user of the apparatus, the limb having at least first and second segments each having axes and communicating by a joint. The modular apparatus may have a modular seat; a modular limb support separate from and positioned in front of the seat to receive the limb of a user when the user is in a position sitting in the seat; a vibration system communicating with the limb support to provide a vibration force to the feet within a first excursion range; a restoring element communicating with the limb support to provide a restoring force to the limb support over a second excursion range larger than the first excursion range wherein the restoring force is dependent on displacement of the limb support from a neutral position; and a modular user joint restraint constraining motion of the user's limb against force exerted on the user's limb by the vibration system and restoring force. The modular limb support and modular user joint restraint may be removably coupled to the modular apparatus and interchangeably replaceable.

It is thus a feature of at least one embodiment of the invention to provide a base system that can be procured at a lower cost, and add-ons that can be procured by a user as funding becomes available or as the need arises for such add-ons to build a more robust system.

The modular limb support may be interchangeable to change a dimension of the limb support. The limb support may further comprise a modular heel rest to receive a heel of a user when the user is in a position sitting in the seat. The modular heel rest may be interchangeable to change a length of the heel rest.

A connecting structure may magnetically couple the limb support and the restoring element.

The restoring force of the limb support may be substantially linear.

These particular objects and advantages may apply to only some embodiments falling within the claims and thus do not define the scope of the invention.

### BRIEF DESCRIPTION OF THE DRAWINGS

FIG. 1 is a perspective view of one embodiment of the present invention providing seated vibration therapy;

FIG. 2 is a simplified side elevational view of the embodiment of FIG. 1 showing modularity of the various elements including a knee brace assembly and a foot platform assembly attached to an actuator assembly both with respect to a user seated in the apparatus;

FIG. 3 is a simplified side elevational view of a foot platform assembly in a neutral position showing the principal components including a housing, a foot platform, and a rocker supporting the housing;

FIG. 4 is a simplified side elevational view of the foot platform assembly of FIG. 3 showing the foot platform assembly displaced from the user in an upright position and against the weight of the foot platform assembly;

FIG. 5 is a simplified side elevational view of the foot platform assembly of FIG. 3 showing the foot platform continuing to be displaced from the user in a fully tilted position and against the weight of the foot platform assembly;

FIG. 6 is a simplified side elevational view of a second embodiment of the foot platform assembly showing the principal components including a housing, a foot platform, and a spring providing pivoting displacement of the housing;

FIG. 7 is a simplified side elevational view of the foot platform assembly of FIG. 6 showing pivoting displacement of the housing to displace the foot platform away from the user;

FIG. 8 is a simplified perspective view of one embodiment of the present invention providing a rotating foot support using bungee cords attached to the rotating foot support and held by the user's hands; and

FIG. 9 is a simplified perspective view of the rotating ottoman of FIG. 8 showing the rotating foot support rotating away from the user as they push against the foot support while the user pulls on the attached bungee cords with their hands.

### DETAILED DESCRIPTION OF THE PREFERRED EMBODIMENT

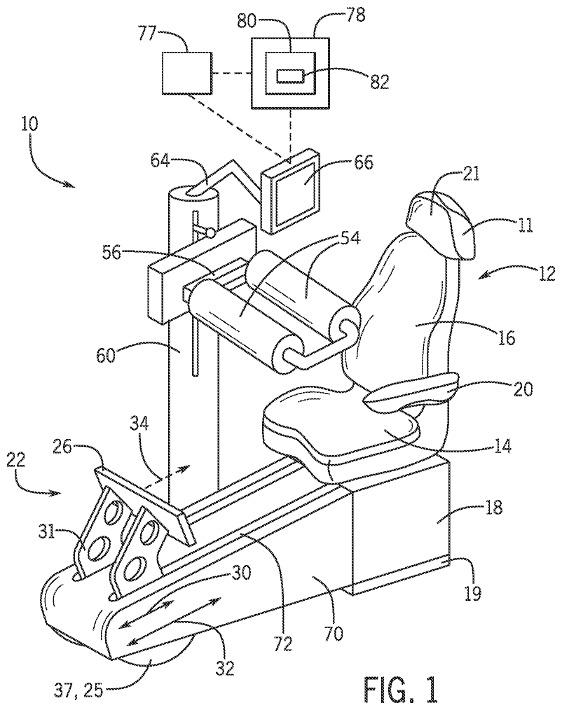

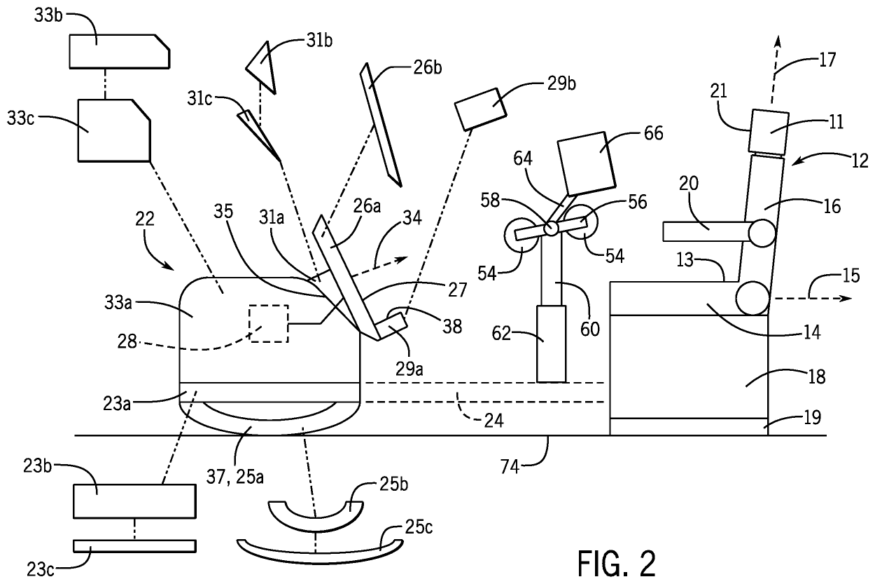

Referring now to FIGS. 1 and 2, a musculoskeletal stimulation device 10 may provide for a seat 12 presenting a substantially horizontal seating surface 14 extending along a horizontal plane 15 and a back support 16 extending upward from a rear edge 13 of the seating surface 14 along a vertical plane 17. The seat 12 may be positioned on an upstanding pedestal 18 comprising a box frame supported on a pedestal support structure 19. The pedestal support structure 19 supports the pedestal 18 above the floor 74 and may provide supporting feet extending vertically downward from the four corners of the pedestal support structure 19 or a horizontally extending rectangular platform supported substantially beneath the pedestal support structure 19.

The back support 16 may be adjustable in inclination (reclining) to deviate from the vertical plane 17 as is generally understood in the art and may provide left and right arm supports 20 extending horizontally forward so that a seated user on the seat 12 may rest his or her forearms on the arm supports 20. The arm supports 20 may be pivotable upward against the sides of the back support 16 to facilitate ingress and egress from the seat 12. The back support 16 may provide a headrest 11 extending vertically upward along vertical plane 17 so that the seated user on the seat 12 may rest the back of his or her head on a support surface 21 of the headrest 11. The seat 12 may swivel about a vertical axis to facilitate ingress and egress.

The seat 12, back support 16, arm supports 20, headrest 11, pedestal 18, and pedestal support 19 are each integrally constructed modular components which may be connected and disconnected from each other as desired to assemble or disassemble the device 10. Connection mechanisms between modular components may cooperate to form joined components as is generally understood in the art. For example, the modular components may be joined by pins and sockets, interlocking fasteners, clamps, etc. Each of the modular components may be interchangeable with a variety of different sized components adopting to the various uses of the device 10 and its users. For example, the height or width of the seat 12, pedestal 18, or pedestal support 19 may be adjusted by interchanging seat 12, pedestal 18, or pedestal support 19 components of varying dimensions. It is understood that the modular components may include interchangeable components having different shapes, sizes, weights, material composition and aesthetic qualities.

Referring to FIG. 2, the pedestal 18 and pedestal support 19 support the seat 12 above the floor 74 and may be located relative to a force unit 22 so that the force unit 22 is positioned in front of the seat 12. Relative fixation between the seat 12 and the force unit 22 may be provided either by means of a connecting structure 24 communicating between the pedestal 18 or pedestal support 19 and the force unit 22 or by connection of both the pedestal 18 or pedestal support 19 and the force unit 22 directly to the floor 74 which then provides for this mechanical communication. Alternatively, relative fixation between the seat 12 and the force unit 22 may be provided for by sufficiently high friction forces between the floor 74 and the force unit 22 as well as between the floor 74 and the pedestal 18 or pedestal support 19 that exceed the force generated or applied through a user's legs.

Referring again to FIGS. 1 and 2, the force unit 22 supports a foot plate 26a facing the seat 12, for example, a textured foot plate 26a providing high friction forces between the user's feet and the textured foot plate 26a. The foot plate 26a is positioned to receive the feet of the user on a support surface 27 when the user is positioned in the seat 12 with his or her feet slightly elevated with bent knees. In this respect, the top of the foot plate 26a may angle away from the user by about 30 degrees from vertical. Pressure by the feet and legs of the user against the foot plate 26a is resisted by the structure of the force unit 22 communicating through the connecting structure 24 or floor 74 to the pedestal 18 and the back support 16. The foot plate 26a may be a modular component that may be interchanged to provide a thinner foot plate 26b or otherwise different dimensions of foot plate 26a. Other variations may include different textures of the foot plate 26a surface and foot plates including at least two separate foot plates for each user foot which may be separately vibrated or force applied.

The foot plate 26a supports a heel support 29a extending toward the user generally normal to the support surface 27 of the foot plate 26a so that heels of the feet of the user when the user is positioned in the seat 12 are supported below by the heel support 29a. In this respect, a support surface 38 of the heel support 29a may angle away from the user by about 30 degrees from horizontal or an angle generally corresponding with the sloping angle of the top of the foot plate 26a. The heel support 29a may be a modular component that may be optionally installed or interchanged to provide a thicker heel support 29b or otherwise different dimensions of heel support 29a. The foot plate 26a may include mounting holes for attachment of the heel support 29a and other modular attachments such as upper extremity attachments and exercise attachments.

A rear surface of the foot plate 26a may attach to a plate adapter 31a of the force unit 22. The plate adapter 31 a may assist with desired angulation of the foot plate 26a to support the user's feet at the desired angle. In one embodiment, as seen in FIG. 2, the plate adapter 31a may provide angulation to the foot plate 26a by increasing or decreasing the thickness of the plate adapter 31a. For example, the plate adapter 31a may be a wedge having a thick end tapering to a thin end whereby the thin end supports a bottom of the foot plate 26a and the thick end supports the top of the foot plate 26a. The plate adapter 31a may be a modular component that may be interchanged to provide a thicker wedge 31b or thinner wedge 31c. For example, the thickness of the thick end may be decreased to increase the slope of the foot plate 26a from vertical and the thickness of the thick end may be increased to decrease the slope of the foot plate 26a from vertical. The plate adapter 31a may be magnetic to attach to magnetic components of the foot plate 26a and housing 33a for ease of attachment.

In one embodiment, the plate adapter 31 may articulate about a jointed component, such as a hinge for lateral side to side rocking motion, a ball joint for 360 degree rolling motion, or another articulating surface that maintains a controlled relative motion between the footplate 26 and the housing 22. Adjustable articulation forces can be achieved whereby articulation is completely free and very little effort is required to articulate the jointed component or whereby an increased resistance makes it more difficult to articulate the joint.

A rear surface of the plate adapter 31a may attach to a housing 33a supported above the floor 74 by a housing support 23a defined by bearings extending downwardly from the corners of the housing 33a and sliding along a rail, for example, provided by connecting structure 24 to change the relative location of the force unit 22 with respect to the seat 12. Movement of the force unit 22 along the rail may be facilitated by a magnetic load transfer assembly utilizing magnets to transmit the housing 33a along the rail. The housing support 23a may also be a horizontally extending platform supported beneath the housing 33a and providing an attachment surface for the restoring element 37, as further described below, or providing high friction forces between the floor 74.

In one embodiment, the housing 33a may have a beveled top edge 35 receiving the plate adapter 31a and promoting rearward sloping of the foot plate 26a by providing a beveled edge having an angle away from the user of about 400 from vertical and receiving the plate adapter 31a to decrease the angle of inclination. For example, the plate adapter 31a may decrease the angle of the beveled top edge 35 to angle the foot plate 26a at an angle away from the user of about 300 from vertical.

The housing 33a and the housing support 23a may be modular components that may be interchanged to provide components 33b, 33c and 23b, 23c, respectively, of different shapes or sizes. For example, the housing support may take various constructions providing varied angled positioning of the foot plate 26a. It is also contemplated that the housing support 23a may be omitted and instead the housing 33a supported directly on the floor 74 or supported by a restoring element 37 as further described below.

Referring to FIG. 1, a base housing 70 may extend over the housing 33a and housing support 23a and further extend to cover the connecting structure 24, pedestal 18 and pedestal support 19 as desired to protect its contents from ingress of dirt and debris. Longitudinally extending slots 72 may allow the plate adapter 31a to extend through the base housing 70 allowing the foot plate 26a to reside outside of the base housing 70 while still communicating with the interior housing 33a. The slots 72 may extend between the force unit 22 and the seat 12 and allow the force unit 22 to be moved closer or farther away from the seat 12 depending on the length of the user's legs and the desired bend of the user's legs.

The housing 33a may support or hold an actuator assembly 28 of the force unit 22 communicating with the foot plate 26a to impart a vibration motion 30 to the foot plate 26a along an actuation axis 34 generally normal to the support surface 27 of the foot plate 26a and aligned with the lower leg of the user. The vibration motion 30 may impart time-varying oscillations to the foot plate 26a at a temporal frequency which may be periodic or random. The oscillations may have a response magnitude defined by an excursion range about an equilibrium point that is less than the magnitude generally needed to compress the muscles of the legs. In one embodiment, the vibration motion 30 may be provided by a vibrating motor (e.g., eccentric rotating mass vibration motor (ERM)) communicating with the foot plate 26a. In an alternative embodiment, the vibration motion 30 may be provided by a pump that when pressed initiates spinning of a rotational component with an off-center mass. Spinning of the eccentrically-weighted rotational component causes vibration motion 30 which is translated to the pump and the foot plate 26a. The pump may be pressed by applying a force on the foot plate 26a, for example, by the user's feet applying force to the foot plate 26a. The pump may be adapter 31 or a part of plate adapter 31.

The force unit 22 may further include a restoring element 37 imparting a restoring force 32 to the foot plate 26a substantially along the actuation axis 34. The restoring force 32 is greater than the forces applied by the vibration motion 30 to provide greater compression and expansion forces on the user's legs, not provided by the vibration motion 30 alone. An excursion range of the restoring force 32 is greater than the excursion range of the vibration motion 30 to provide a greater range of compression and expansion forces on the user's legs not provided by the vibration motion 30 only. Generally, the vibration motion 30 and the restoring force 32 may be actively resisted by conscious muscular action of the user in a dynamic mode or passively resisted by structure of the legs of the user as braced against knee bolsters 54 limiting the bending of the knees of the user in a passive mode. In another embodiment, the restoring force may be resisted by the weight of the user's legs without a supporting structure for the knees. In all cases, the muscles of the legs of the user are contracted by the vibration motion 30 through a natural stretch reflex of the muscles. Due to motion of the restoring element 37, the restoring force 32 is applied at a range of motion that articulates the joints and enables the muscles of the legs to pass through their optimal length for greatest force generation capacity.

The restoring element 37 imparts the restoring force 32 against the foot plate 26a toward the user as the lower leg of the user extends to displace the foot plate 26a away from the user. The restoring force 32 decreases as the displacement of the foot plate 26a is increased and the restoring force 32 increases as the displacement of the foot plate 26a is decreased.

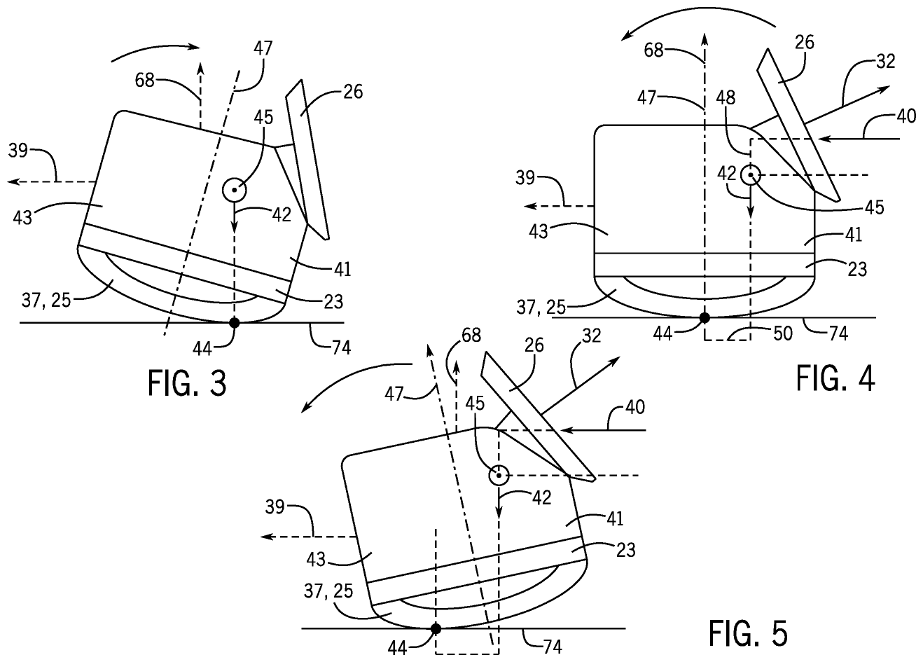

In one embodiment, as shown in FIGS. 3 through 5, the restoring element 37 is provided by a rocker 25a supporting the housing support 23a above a floor 74. The rocker 25a may be one or more arched structures extending between a front 41 of the housing 33a supporting the foot plate 26a and proximate the user, and a back 43 of the housing 33a away from the user, and providing a curved contact surface contacting the floor 74 at a point or along a line of points between the front 41 and back 43 of the housing 33a and allowing for forward rocking toward the user and backward rocking away from the user generally along a horizontal displacement axis 39.

Referring to FIG. 3, when the force unit 22 is at a neutral position without any application of forward force 40 by the user, a center of mass 45 is located in a forward position with respect to a centerline 47 of the force unit 22 centered between the front 41 and back 43 of the housing 33a. As such, a weight 42 of the force unit 22 is directed downwardly at the center of mass 45 causing an instantaneous point of rotation 44 to be located in a forward position on the curved contact surface such that the rocker 25a is tilted toward the user in the neutral position.

Referring to FIG. 4, when a forward force 40 is imparted by conscious or passive muscular action of the user when he or she applies a forward force 40 against the foot plate 26a along actuation axis 34, the rocker 25a may be rocked backward causing the instantaneous point of rotation 44 to move backward along the curved contact surface such that the rocker 25a is tiled away from the user. As seen in FIG. 4, the instantaneous point of rotation 44 is positioned along the centerline 47 such that the rocker 25a is in an upright, non-tilted position.

Referring to FIG. 5, when the forward force 40 continues to be imparted by the user, the instantaneous point of rotation 44 moves backward along the curved contact surface to a rear position with respect to the centerline 47 such that the rocker 25a is tilted away from the user.

As the forward force 40 is applied to the foot plate 26a by the user, the rocker 25a is tilted away from the user and the foot plate 26a and center of mass 45 are displaced along horizontal displacement axis 39 away from the user and raised along a vertical displacement axis 68. The displacement along the horizontal displacement axis 39 and vertical displacement axis 68 causes the joint range of motion of the user's leg to change throughout the displacement.

The moment arm 48 between the center of mass 45 and the applied forward force 40 is greater as the rocker 25a is tilted away from the user if the line of action of force 40 is above center of mass 45. The moment arm 50 between the instantaneous point of rotation 44 and the applied weight 42 (weight of the force unit 22) is lower as the rocker 25a is tilted away from the user. In this respect, the restoring force 32 decreases as the rocker 25a is tilted away from the user and displacement is greatest and the restoring force 32 increases as the rocker 25a is tilted toward the user and displacement is smallest. Adjusting the position of center of gravity 45 and changing the contour of rocker 25 and changing the position of applied force 40 has the effect of modifying restoring force 32 as the rocker tilts toward and away from the user.

The rocker 25a may be a modular component and may be interchangeable to provide rockers 25b, 25c of varying radius of curvature, including a curve made of any number of connecting lines such that there are a finite number of points along the floor 74 about which the force unit tilts.

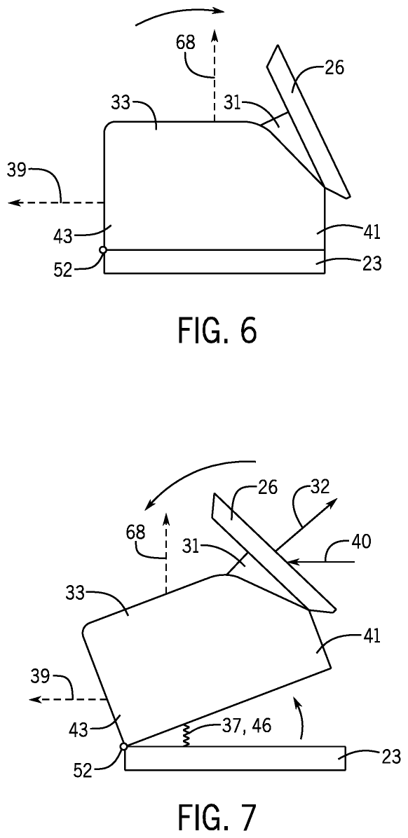

In an alternative embodiment, as shown in FIGS. 6 and 7, the restoring element 37 may alternatively be a spring 46 or spring hinge operating to displace the foot plate 26a along the horizontal displacement axis 39 and vertical displacement axis 68. The housing 33a may be in pivotable relationship with the housing support 23a or may be in a pivotable relationship directly with the floor 74 whereby the housing 33a pivots about a pivot axis 52 extending generally horizontally along a bottom edge of the back 43 of the housing 33a to tilt the housing 33a between a substantially horizontal position (FIG. 6) and an upward direction displaced away from the user (FIG. 7).

Referring to FIG. 6, when the force unit 22 is at a neutral position without any application of forward force 40, the housing 33a may be substantially horizontal and extending along displacement axis 39. The spring 46 or spring hinge biases the housing 33a in the horizontal position.

Referring to FIG. 7, when the forward force 40 is imparted by conscious muscular action of the user when he or she pushes against the foot plate 26a, the housing 33a pivots upward away from the user. The forward force 40 causes displacement of the foot plate 26a along the displacement axis 39 away from the user and raises along the vertical displacement axis 68. In response, the spring 46 or spring hinge applies the restoring force 32 on the foot plate 26a which is translated to the foot plate 26a and applied to the feet of the user. The restoring force 32 decreases when the housing 33a is tilted away from the user as the displacement increases and the restoring force 32 increases when the housing 33a is tilted toward the user as the displacement decreases.

In an alternative embodiment, the forward force 40 may be imparted by the user as separate forces on each respective foot. In this respect the foot plate 26a may include separate plates receiving each of the user's feet. The forward force 40 of one foot may generate the restoring force 32 on the opposite foot and vice versa. In this respect the restoring element 37 may include weights or springs in cooperating operation with the separate vibration plates 26a.

Referring now to FIGS. 1 and 2, bolsters 54 may be generally padded cylinders extending across actuation axis 34 to fit on either side of the knees as separated by an equalizer arm 56. The equalizer arm 56 extending between the bolsters 54 may pivot at a pivot 58 midway along the equalizer arm 56 and join the equalizer arm 56 to one and of a swing arm 60. The swing arm 60 may communicate to its opposite end with the connecting structure 24 through a second pivot 62. In this way, the bolsters 54 may be moved down against the knees of the user by downward rotation of the swing arm 60 with rotation of the bolsters 54 about the pivot 58 equalizing force above and below the knees of the user. Alternatively, the swing arm 60 may be moved upward to move the bolsters 54 away from the knees of the user to allow the user to freely exit the device 10. In one embodiment of the present invention, the swing arm is not attached to the connecting structure 24 but is a free-standing structure that is supported on the floor 74 by locking rollers that allow the bolsters 54 to be rolled to the desired location but is not fixed to the device 10.

The swing arm 60 may also support a device arm 64 supporting a user interface 66, for example, providing a touchscreen for receiving commands from the user and providing a display to the user. It is understood that the commands may also be received through physical buttons or virtual buttons shown on the user interface 66.

The various components of the device 10 may be controlled by a controller 77 providing one or more electronic computer 78 processors communicating with electronic memory 80 for storing a program 82 to be executed by the electronic computer 78 according to data and the program 82 in the memory 80. The memory 80 provides a non-transient storage medium for the program 82.

The controller 77 may communicate with the user interface 66, the actuator assembly 28, and the restoring element 37 for electronically controlling the vibration motion 30 and restoring force 32. For example, the controller 77 may operate to change the vibration motion 30 and restoring force 32 depending on the operating program 82 to provide strength assessments, range of motion assessments, and other assessments. For example, the operating program 82 may monitor the amount of forward force 40 acting on the foot plate 26a and provide feedback to the patient, therapist, or other third party through the user interface 66 or other monitor to show force versus time for varying amounts of vibration motion 30 and restoring force 32. In another example, the patient is instructed to maintain a constant forward force 40 as the amounts of vibration motion 30 and restoring force 32 applied changes. The amount of forward force 40 applied by the user may be indicated on the user interface 66. A score is provided to the user at the end of the session. In another example, the operating program 82 may monitor the amount of movement 32 of the foot plate 26a and provide feedback to the patient, therapist, or other third party through the user interface 66 or other monitor to show the range of motion of the user's limb and the restoring force 32 as a function of range of motion.

The program 82 may further provide instructions to the user interface 66 in order to communicate passive range of motion exercises, active exercises, cognitive exercises, team competitive and collaborative exercises, remote competitive and collaborative exercises to the user in connection with use of the device 10. The program 82 may also provide assessment tools such as range of motion testing (via stepper motor count), strength testing (via load cell), circulation testing (via thermal imaging), stress testing (via skin conductance), cognitive testing (via on-screen assessments), and vibro-tactile sensation testing. Other programs 82 may include educational and training software and service and maintenance programs 82.

Results of the program 82 may be reported to the user and/or outside third parties customized to each particular user. Third parties receiving the reporting information may use the information to gather global data, make comparisons between users, and assess the progress of the user. Results of the program 82 may also be communicated through social media.

Additional modular components may be optionally attached to the device 10 including body positioning mechanisms, for example, knee supports (manual or automatic), posture alignment supports, cushions; exercise attachments, for example, seated row via foot braces plus handles attached to the foot plate 26a), bench press (via push bar attached to the foot plate 26a) and straps 76 or handles; and sensors, for example, load cells, limit switches, tilt sensors, accelerometers, biosensors.

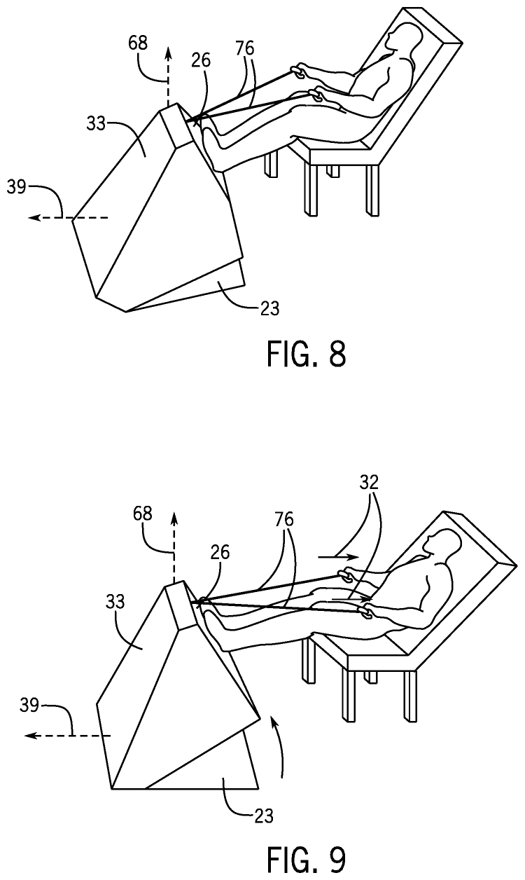

Referring to FIGS. 8 and 9, in one embodiment of the present invention, the force unit 22 may be a standalone exercise device whereby the foot plate 26a is supported by a rocking or pivotable housing 33a (similar to the housing 33a shown in FIGS. 3 through 7) whereby the restoring force 32 is applied by gravity (without straps 76) or the user (with straps 76). The foot plate 26a may be integral with the housing 33a such that an angled foot plate 26a provides a side of the housing 33a as shown.

In one embodiment, the restoring element 37 may be a strap 76 attached to a top end of the foot plate 26a such that a first end is affixed to the foot plate 26a and an opposite end is held by the user's hands. The opposite end may include handles. Strap 76 may be elastic or not (as in the case of the strap 76 forming a handle).

Referring to FIG. 8, when the force unit 22 is at a neutral position without any application of forward force 40, the housing 33a may be substantially horizontal and extending along displacement axis 39. When the forward force 40 is imparted by conscious muscular action of the user when he or she pushes against the foot plate 26a, the housing 33a pivots upward away from the user. The forward force 40 causes displacement of the foot plate 26a along the displacement axis 39 away from the user and raised along the vertical displacement axis 68. The user then pulls on the bungee cord 76 to cause the housing 33a to pivot back toward the user to apply the restoring force 32 on the foot plate 26a which is translated to the feet of the user. Alternatively, the restoring force 32 can be the force of gravity when the location of the center of gravity 45 of force unit 22 is proximal the point about which force unit 22 rocks on floor 74.

The inventors contemplate that the present invention is not limited to use on the legs but may find use as an analogous system for exercising the arms or other portions of the body.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

1. An apparatus for applying an axial vibratory force to a limb of a user of the apparatus, the limb having at least first and second segments each having axes and communicating by a joint, the apparatus comprising:
a limb support to receive the limb of a user;
a vibration system communicating with the limb support to provide a vibration force to the limb within a first excursion range; and
a restoring element communicating with the limb support to provide a restoring force to the limb support over a second excursion range larger than the first excursion range wherein the restoring force is dependent on displacement of the limb support from a neutral position.

2. The apparatus of claim 1 wherein the restoring element is a weight having a center of gravity and communicating with the limb support whereby the center of gravity is lifted along a vertical axis when the limb support is displaced.

3. The apparatus of claim 2 wherein the weight is provided by a rocker providing rocking movement of the limb support toward and away from the user whereby displacement of the limb support occurs when rocking away from the user and the restoring force is applied to the limb support when rocking toward the user.

4. The apparatus of claim 3 wherein the rocker is interchangeable to change a radius of curvature of the rocker.

5. The apparatus of claim 1 wherein the restoring element is a spring communicating with the limb support to compress or extend the spring when the limb support is displaced.

6. The apparatus of claim 5 wherein the spring is a spring-loaded hinge whereby displacement of the limb support occurs when rotating the limb support away from the user and the restoring force is applied to the limb support when rotating the limb support toward the user.

7. The apparatus of claim 1 wherein the limb supports are two separately displaceable limb supports receiving each of the user's limbs separately and the restoring force is generated by the displacement of an opposite limb support.

8. The apparatus of claim 1 wherein the limb support is interchangeable to change a dimension of the limb support.

9. The apparatus of claim 1 wherein the limb support further comprises a heel rest to receive a heel of a user when the user is in a sitting position.

10. The apparatus of claim 1 wherein the restoring element provides a strap receivable by a user's hands to provide the restoring force.

11. The apparatus of claim 1 further comprising a user interface communicating a user assessment.

12. The apparatus of claim 1 wherein displacement of the limb support is along at least two orthogonal directions.

13. A modular apparatus for applying an axial vibratory force to a limb of a user of the apparatus, the limb having at least first and second segments each having axes and communicating by a joint, the modular apparatus comprising:
a modular limb support to receive the limb of a user;
a vibration system communicating with the limb support to provide a vibration force to the feet within a first excursion range; and
a restoring element communicating with the limb support to provide a restoring force to the limb support over a second excursion range larger than the first excursion range wherein the restoring force is dependent on displacement of the limb support from a neutral position.

14. The modular apparatus of claim 13 wherein the restoring element is a weight having a center of gravity and communicating with the limb support whereby the center of gravity is lifted along a vertical axis when the limb support is displaced.

15. The modular apparatus of claim 14 wherein the restoring element comprises a modular rocker applying the restoring force to the limb support when rocking toward the user.

16. The modular apparatus of claim 13 wherein the restoring element is a spring communicating with the limb support to compress the spring when the limb support is displaced.

17. The modular apparatus of claim 13 wherein the limb support is interchangeable to change a dimension of the limb support.

18. The modular apparatus of claim 13 further comprising a user interface communicating a user assessment.

19. (canceled)

20. The modular apparatus of claim 13 wherein the restoring force of the limb support is substantially linear.
